(19) United States
(12) Patent Application Publication
(10) Pub. No.: US 2025/0231551 A1
(43) Pub. Date: Jul. 17, 2025

(54) COMPUTER-SUPPORTED MANUFACTURING METHOD, AND MANUFACTURING SYSTEM

(71) Applicant: TRUMPF Werkzeugmaschinen SE + Co. KG, Ditzingen (DE)

(72) Inventors: Wolf Wadehn, Tamil Nadu (IN); Christian Görg, Möglingen (DE); Klaus Bauer, Ditzingen (DE); Hans-Peter Bock, Bietigheim- Bissingen (DE)

(21) Appl. No.: 19/171,400

(22) Filed: Apr. 7, 2025

Related U.S. Application Data
(63) Continuation of application No. PCT/EP2023/076948, filed on Sep. 28, 2023.

(30) Foreign Application Priority Data
Oct. 7, 2022 (DE) 10 2022 125 985.4

(51) Int. Cl. G05B 19/418

(52) U.S. Cl. CPC G05B 19/41865; G05B 19/41875; G05B 2219/49061

(57) ABSTRACT

A computer-supported manufacturing method for manufacturing workpieces from a workpiece blank according to a manufacturing plan using a machine tool (18), has a processing device. The method includes at least partly transmitting the manufacturing plan by means of an order control device. At least one work piece is manufactured from the workpiece blank according to the manufacturing plan. The manufacturing progress of the processing device is determined during the manufacturing of the at least one workpiece by the order control device. The manufacturing plan is changed on the basis of the manufacturing progress during the manufacturing of the at least one workpiece by means of the order control device.

### CROSS REFERENCE TO RELATED APPLICATIONS

This application is a continuation of International Application No. PCT/EP2023/076948 (WO 2024/074403 A1), filed on Sep. 28, 2023, and claims benefit to German Patent Application No. DE 10 2022 125 985.4, filed on Oct. 7, 2022. The aforementioned applications are hereby incorporated by reference herein.

### FIELD

The disclosure relates to a computer-supported manufacturing method for manufacturing workpieces from a workpiece blank by means of a machine tool. The disclosure also relates to a manufacturing system with a processing device and an order control device.

### BACKGROUND

Such methods are typically used in the processing of workpiece blanks in the form of sheet metal, which can be fed to the machine tool as sheet metal panels or sheet metal rolls. In addition, such methods can be used in the processing of materials. Cutting machines, in particular laser cutting machines, and/or punching machines are often used for processing the workpiece blanks.

In order to maximize the efficiency of the machine tool while using the workpiece blanks as sparingly as possible, the workpieces to be manufactured are arranged as densely as possible on a workpiece blank and the manufacturing plan is only approved for processing by means of the machine tool when the workpiece blank is highly utilized or the workpiece density is high. For this purpose, workpieces from several manufacturing orders typically have to be combined into one manufacturing plan. If a workpiece blank is not fully utilized by a manufacturing order, the processing of the manufacturing order is delayed or the processing takes place with a high level of material waste.

In addition, a variety of influences during laser cutting can lead to a workpiece being damaged during the manufacturing or being manufactured incorrectly by the machine tool. Such damaged or defective workpieces can be detected by the machine tool or the operator and then be reworked in order to fully complete a manufacturing order.

Common methods require that faulty or damaged workpieces are either laboriously reworked manually by an operator or are manufactured from a subsequent workpiece blank by the machine tool.

In all cases, reworking these faulty or damaged workpieces leads to significant delays, meaning that manufacturing orders cannot be completed. In order to enable continued operation of the machine tool, additional storage space is provided for the temporary storage of incomplete manufacturing orders.

Delays in processing manufacturing orders can also lead to failure to meet delivery deadlines. In such cases, the ongoing manufacturing process of the machine tool often has to be interrupted in order to manufacture faulty or damaged workpieces on an additional workpiece blank, resulting in high material waste. This reduces the level of automation of the machine tool and subsequent manufacturing orders can be significantly delayed.

To prevent delays, it is therefore often provided that individual or all workpieces of a manufacturing order are manufactured twice or multiple times. In other words, reserve workpieces are produced to replace faulty and/or damaged workpieces if necessary. Unneeded reserve workpieces are then disposed of. This leads to considerable material waste and a significantly longer manufacturing time and therefore does not represent an adequate solution to the problems described above.

### SUMMARY

In an embodiment, the present disclosure provides a computer-supported manufacturing method for manufacturing workpieces from a workpiece blank according to a manufacturing plan using a machine tool having a processing device. The method includes: at least partly transmitting the manufacturing plan using an order control device; manufacturing at least one workpiece from the workpiece blank according to the manufacturing plan using the processing device; determining a manufacturing progress of the processing device during the manufacturing of the at least one workpiece using the order control device; and changing the manufacturing plan on the basis of the manufacturing progress during the manufacturing of the at least one workpiece using the order control device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a manufacturing method according to embodiments of the present disclosure, for manufacturing workpieces in a schematic representation;

FIG. 2 shows a manufacturing system with a processing device and an order control device for carrying out an exemplary first embodiment of the manufacturing method, according to embodiments of the present disclosure, according to FIG. 1 in a schematic representation; and

FIG. 3 shows the manufacturing system from FIG. 2 for carrying out an exemplary second embodiment of the manufacturing method according to embodiments of the present disclosure.

### DETAILED DESCRIPTION

In accordance with an embodiment, the present disclosure provides a method for manufacturing workpieces which enables manufacturing orders to be processed with little delay while maintaining a high degree of autonomy in a resource-saving manner. Furthermore, in accordance with another embodiment, the present disclosure discloses an appropriate manufacturing system.

The manufacturing method is suitable for manufacturing workpieces from a workpiece blank. A workpiece blank can be provided as sheet material, for example in the form of a metal sheet, and/or as rolled material, for example in the form of a metal roll or a fabric roll.

The method provides for the use of a machine tool, in particular a flat-bed machine tool, with a processing device. The processing device can be designed, for example, as a cutting machine or punching machine.

The workpieces are manufactured from the workpiece blank by means of the machine tool according to a manufacturing plan. The manufacturing plan comprises at least one workpiece to be manufactured. Preferably, the manufacturing plan comprises several, particularly preferably a plurality of, workpieces to be manufactured. The manufacturing plan can have a workpiece grouping with several related workpieces, for example of a common assembly. In such cases, the method features described here and below may also refer to workpiece groupings. The manufacturing plan can contain workpieces and/or workpiece groupings from different manufacturing orders.

The manufacturing plan typically contains geometric manufacturing information about the workpieces to be manufactured, for example one or more workpiece dimensions, a workpiece contour and/or a workpiece position on the workpiece blank. The manufacturing information is preferably coded in a machine-readable manner and contains all relevant information that enables the workpieces to be, in particular automatically, manufactured. In other words, manual handling by an operator is no longer necessary.

The manufacturing plan typically has geometric dimensions that do not exceed the processing range of the processing device. The workpiece blank is preferably designed to be adapted to the processing area of the processing device. In the case of workpiece blanks that protrude beyond the processing area of the processing device, for example workpiece blanks in the form of rolled goods, the manufacturing plan can be limited to a workpiece blank section that corresponds to the processing area of the processing device.

In a method step of the manufacturing method, the manufacturing plan is at least partly transmitted by means of an order control device. Typically, the manufacturing plan is transmitted in full to the processing device. The order control device is typically designed to automatically create and/or transmit the manufacturing plan. When creating the manufacturing plan, the workpieces to be manufactured are preferably arranged or nested on the workpiece blank to be machined, based on underlying manufacturing orders with a discrete specification of the workpieces to be manufactured. The order control device can include computer algorithms, in particular self-learning computer algorithms, which optimize the arrangement or nesting of the workpieces on the workpiece blank. This can increase the utilization of the available workpiece blank.

In a further method step, at least one workpiece is manufactured from the workpiece blank according to the manufacturing plan. In other words, the machine tool begins manufacturing the workpieces. Typically, the workpiece blank was fed, in particular directly, to the processing area of the processing device beforehand.

In a further method step, the manufacturing progress of the processing device during the manufacturing of the workpieces is determined by the order control device. In other words, the order control device determines the workpieces that have already been manufactured according to the manufacturing plan. The manufacturing progress can be determined, for example, at fixed time intervals and/or at certain events during the processing of the manufacturing plan, for example when a workpiece is completed.

A further method step provides for changing the manufacturing plan on the basis of the manufacturing progress during the manufacturing of the workpieces by means of the order control device. The order control device can, for example, provide for a change in the arrangement of unfinished workpieces and/or the reworking of workpieces that have already been manufactured.

According to embodiments of the present disclosure, a manufacturing method is thus disclosed which provides for a change in the manufacturing plan during the manufacturing of workpieces in the machine tool by means of the order control device. This means, for example, that the machine tool can start processing an order before the workpiece blank has been completely filled with workpieces to be finished. Full occupancy can be achieved during manufacturing by changing the manufacturing plan. Furthermore, a damaged or faulty workpiece can be easily reworked on the same workpiece blank. In all cases, delays in processing manufacturing orders can be reduced.

In a preferred embodiment of the computer-supported manufacturing method, the machine tool is designed as a laser cutting machine. The use of the manufacturing method in conjunction with a laser cutting machine was found to be particularly advantageous by the inventors.

Further preferred is an embodiment of the computer-supported manufacturing method in which the manufacturing plan for the unfinished workpieces is changed.

In a preferred further development of the computer-supported manufacturing method, the workpieces are manufactured by means of the processing device according to a manufacturing sequence specified in the manufacturing plan, wherein the order control device changes the manufacturing sequence of the unfinished workpieces of the manufacturing order during the manufacturing of the workpieces. This can avoid delays in the completion of a manufacturing order, for example by manufacturing an identical workpiece for a subsequent manufacturing order.

Further preferred is an embodiment of the computer-supported manufacturing method in which the order control device supplements the manufacturing plan by at least one further workpiece to be manufactured. Preferably, before the manufacturing plan is changed, the order control device determines, in particular automatically, a free space on the workpiece blank required to add the additional workpiece to be manufactured. The supplementary workpiece to be manufactured can, for example, be an additional workpiece to be manufactured, for example from a subsequent manufacturing order, which increases the utilization of the workpiece blank.

A further development of the computer-supported manufacturing method is preferred, having the method step of identifying a manufactured defective and/or damaged workpiece, wherein the further supplementary workpiece corresponds to the manufactured defective and/or damaged workpiece.

This allows the already manufactured faulty and/or damaged workpiece to be reproduced without significant delay.

In a preferred embodiment of the computer-supported manufacturing method, the order control device removes at least one unfinished workpiece from the manufacturing plan. Preferably, a reserve workpiece that is not required can be removed from the manufacturing plan. This allows a free space to be formed on the workpiece blank for the arrangement of a workpiece that is reproduced and/or a supplementary workpiece.

Another preferred embodiment of the computer-supported manufacturing method is one in which the order control device changes the arrangement of the workpieces that have not yet been manufactured on the workpiece blank. Changing the arrangement of the workpieces preferably leads to a higher degree of occupancy of the workpiece blank with workpieces. Particularly preferably, a change in the arrangement in connection with a removal and/or addition of workpieces in the manufacturing plan can be carried out by means of the order control device. This can speed up the processing of manufacturing orders.

Further preferred is an embodiment of the computer-supported manufacturing method in which the manufacturing plan is divided into at least two manufacturing sections. A manufacturing section is to be understood as a part of the manufacturing plan to be processed independently of the processing device. In other words, the manufacturing section contains all information relevant to the processing device in order to carry out the manufacturing of the workpieces according to the manufacturing section, independently of the rest of the manufacturing plan. The manufacturing sections can thereby be transmitted separately from one another to the processing device by the order control device. In other words, only part of the manufacturing plan is available to the processing device during the manufacturing of the workpieces. This means that changes to the manufacturing plan can be limited, for example, to the manufacturing sections not yet transmitted to the processing device by means of the order control device. The manufacturing plan or a manufacturing section can be changed particularly easily by the order control device without interfering with the manufacturing section to be processed by the processing device.

Preferably, the manufacturing progress can be determined by the order control device by means of the manufacturing sections transmitted from the order control device to the processing device.

In a preferred further development of the computer-supported manufacturing method, each workpiece to be manufactured is manufactured in a separate manufacturing section. In other words, each individual workpiece can be transmitted to the processing device and manufactured by the processing device independently of the rest of the manufacturing plan. In this case, the manufacturing plan can be transmitted to the processing device by a clocked and/or continuous transmission of the individual manufacturing sections.

A further development of the computer-supported manufacturing method is particularly preferred, in which the order control device transmits the manufacturing sections to the processing device on the basis of the manufacturing progress. This allows the manufacturing sections to be transferred depending on the processing speed of the processing device.

A further development of the computer-supported manufacturing method is particularly preferred, in which the order control device transmits a manufacturing section to the processing device when the previously transmitted manufacturing section has been processed by the processing device. This allows for maximum flexibility when changing the manufacturing plan.

In a preferred embodiment of the computer-supported manufacturing method, it can be provided that the processing device sends the manufacturing progress to the order control device during the processing of the manufacturing plan. This ensures that workpieces that have already been manufactured are detected on the basis of up-to-date information.

In a preferred embodiment, the computer-supported manufacturing method comprises a further processing device for manufacturing workpieces according to a further manufacturing plan. It can be provided that the manufacturing plan of one of the processing devices is changed depending on a change in the manufacturing plan of the other processing device. This means that, for example, workpieces that are to be reproduced can be included or arranged in the manufacturing plan or on the workpiece blank of the other processing device. In other words, the workpieces to be manufactured can be processed across machines. This is a particularly effective way of preventing delays in the completion of manufacturing orders.

In accordance with an alternate embodiment, the present disclosure provides a manufacturing system. The manufacturing system comprises at least one processing device and the order control device. Preferably, the manufacturing system comprises at least two, in particular a plurality of, processing devices. Typically, each processing device is assigned to a machine tool.

The order control device can be part of a machine tool. Furthermore, the order control device can be designed as a separate unit. In any case, the order control device is configured for communication or data exchange with at least one processing device.

The order control device is configured to carry out the manufacturing method described above and below. In other words, the order control device is configured for the, in particular automatic, creation and modification of manufacturing plans in the manner described above and below.

Changing manufacturing plans may, for example and not exclusively, involve the addition of additional workpieces, the removal of workpieces, the arrangement of the workpieces, the manufacturing sequence, etc.

Further features and advantages of the disclosure can be found the description, the claims and the drawing. According to embodiments of the present disclosure, the features mentioned above and those yet to be explained further may be used in each case individually or together in any desired expedient combinations. The embodiments shown and described should not be understood as an exhaustive list, but rather are of an exemplary character for describing embodiments of the present disclosure.

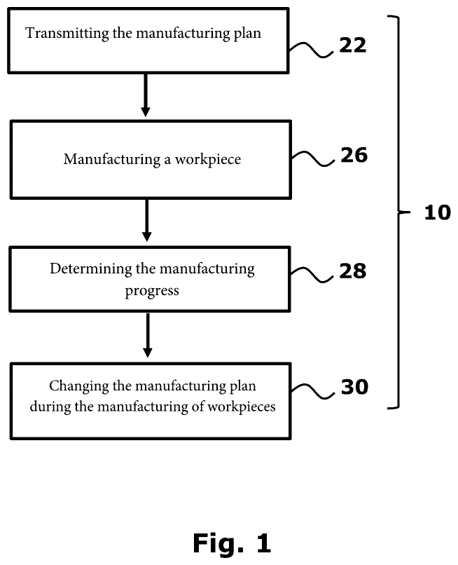

FIG. 1 shows a computer-supported manufacturing method 10 according to the disclosure in a schematic representation.

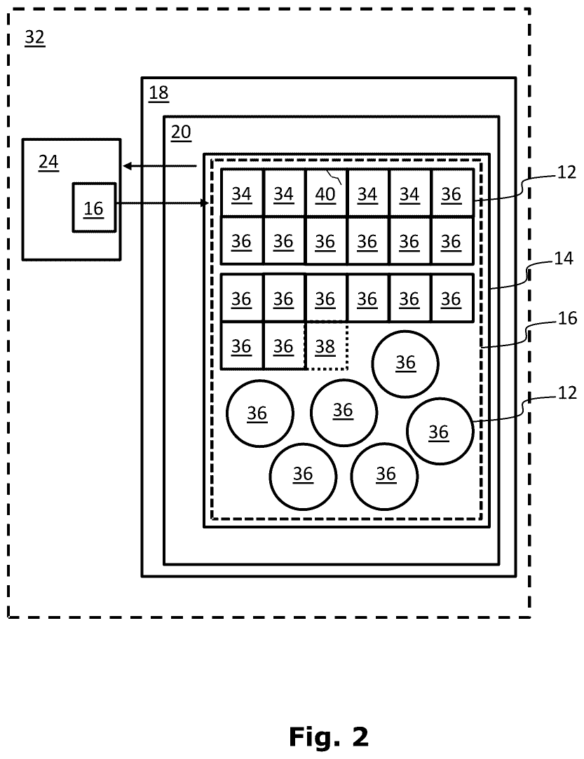

The manufacturing method 10 is designed for manufacturing workpieces 12 (see FIG. 2) from a workpiece blank 14 (see FIG. 2) according to a manufacturing plan 16 (see FIG. 2) using a machine tool 18 (see FIG. 2), in particular a flat-bed machine tool, having a processing device 20 (see FIG. 2).

The manufacturing method has the following method steps:
a) at least partly transmitting 22 the manufacturing plan 16 by means of an order control device 24 (see FIG. 2);
b) manufacturing 26 at least one workpiece 12 from the workpiece blank 14 according to the manufacturing plan 16;
c) determining 28 the manufacturing progress of the processing device 20 during the manufacturing of the workpieces 12 by means of the order control device 24;
d) changing 30 the manufacturing plan 16 on the basis of the manufacturing progress during the manufacturing of the workpieces 12 by means of the order control device 24.

FIG. 2 shows a schematic representation of a manufacturing system 32.

The manufacturing system 32 comprises the processing device 20 and the order control device 24. The processing device 20 is part of the machine tool 18, which is designed for manufacturing workpieces 12 from the workpiece blank 14 according to the manufacturing plan 16. For reasons of clarity, only two workpieces 12 are provided with a reference symbol. According to the embodiment shown, the order control device 24 is designed as a separate unit and is configured for communication with the processing device 20.

In a particular embodiment, it can be provided that the manufacturing system 32 has at least two, in particular several, machine tools 18, each having a processing device 20.

According to the method step 22 “transmitting the manufacturing plan,” the order control device 24 transmits at least part of the manufacturing plan 16 to the processing device 20. The manufacturing plan 16 comprises the manufacturing information necessary for manufacturing the workpieces 12. Manufacturing information can exist, for example, in the form of a workpiece contour, a workpiece position, a manufacturing sequence and/or a machine parameter of the workpiece 12 to be manufactured. As shown, the manufacturing plan 16 has been completely transferred to the processing device 20. In a special embodiment, it can be provided that the manufacturing plan 16 is divided into manufacturing sections, which are transmitted, in particular individually, to the processing device 20. For example, a manufacturing section could concern the manufacture of rectangular workpieces 12, while another manufacturing section could concern the manufacture of round workpieces 12. In addition, each workpiece 12 can be contained in a separate manufacturing section.

In the further method step 26 “manufacturing at least one workpiece,” at least one workpiece 12 is manufactured by the processing device 20 according to the manufacturing plan 16. In FIG. 2, several manufactured workpieces 34 are shown.

In the method step 28 “determining the manufacturing progress,” the manufacturing progress is determined during the processing of the manufacturing plan 16 by means of the order control device 24. In other words, it is possible to determine which workpieces 12 have already been manufactured or are available as manufactured workpieces 34. In addition, it can be determined which workpieces 12 have not yet been manufactured or, as shown, are available as unfinished workpieces 36.

By knowing the manufacturing progress, the manufacturing plan 16 can be changed by the order control device 24 in accordance with the method step 30 “changing the manufacturing plan.” For example, a supplementary workpiece 38 can be added to the manufacturing plan 16. This can be done by utilizing the available free space on the workpiece blank 16. Preferably, the order control device 24 determines, in particular automatically, the free space available for this on the workpiece blank 14.

Furthermore, for example, it may be provided that one or more of the workpieces 12 are damaged and/or manufactured incorrectly during the manufacturing of the workpieces 12. According to FIG. 2, a damaged workpiece 40 is shown. In this case, the manufacturing method 10 can provide for the supplementary workpiece 38 to correspond to the damaged and/or incorrectly manufactured workpiece 40. In other words, the damaged workpiece 40 can be reproduced on the same workpiece blank 14 without delay.

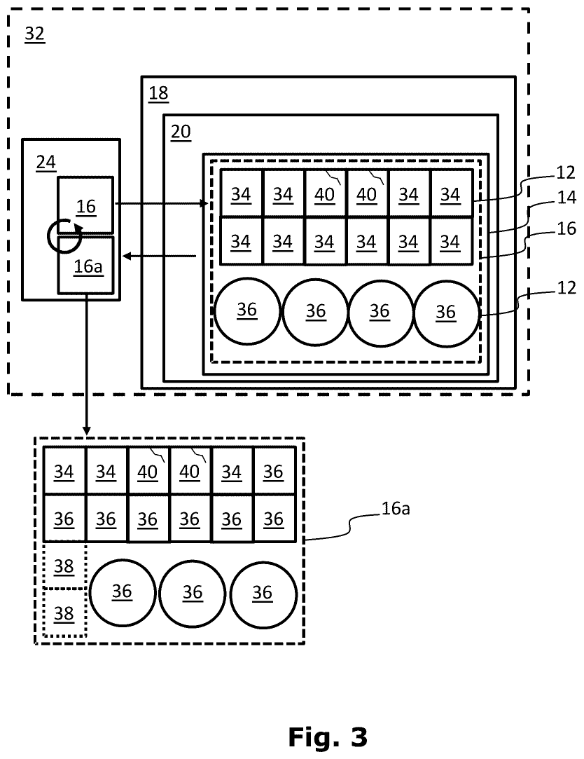

FIG. 3 shows the manufacturing method 32 from FIG. 2 for carrying out a further exemplary embodiment of the manufacturing method 10 from FIG. 1 for explanation.

According to the manufacturing sequence 16, at the beginning of manufacture of the workpieces 12, it is provided that a number of workpieces 12 as shown are to be manufactured from the workpiece blank 14 by means of the processing device 20 of the machine tool 18.

During the manufacturing of the workpieces 12, for example, two damaged workpieces 40 can be detected or identified by the processing device 20. The processing device 20 transmits information, for example the position and type, of the damaged workpieces 40 to the order control device 24.

The order control device 24 determines the manufacturing progress of the processing device 20 when executing the manufacturing plan 16, wherein, for example, the manufactured workpieces 34 and the unfinished workpieces 36 are determined.

The order control device 24 can then make a change to the manufacturing plan 16 on the basis of the manufacturing progress. As shown, it can be provided that the order control device 24 creates a modified manufacturing plan 16a. As shown, the manufacturing plan 16a may include a change in the number of unfinished workpieces 36 to provide the clearance needed for arranging the supplementary workpieces 38 on the workpiece blank 14.

The modified manufacturing plan 16a is then transmitted to the processing device 20, which completes the processing of the workpiece blank 14 according to the modified manufacturing plan 16a.

The omitted workpiece 36 can, for example, be provided in a manufacturing plan 16 of a workpiece blank 14 to be subsequently machined.

Generally speaking, it should be noted that the manufacturing plan 16 can be changed several times, particularly in the case of manufacturing plans 16 that have a large number of workpieces 12 to be manufactured.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

Manufacturing method 10;
Workpiece 12;
Workpiece blank 14;
Manufacturing plan 16, 16a;
Machine tool 18;
Processing device 20;
Method step 22 “transmitting the manufacturing plan”;
Order control device 24;
Method step 26 “manufacturing at least one workpiece”
Method step 28 “determining the manufacturing progress of the processing device”;
Method step 30 “changing the manufacturing plan”;
Manufacturing system 32;
Manufactured workpieces 34;
Unfinished workpieces 36;
Supplementary workpiece 38;
Damaged workpiece 40.

What is claimed is:

1. A computer-supported manufacturing method for manufacturing workpieces from a workpiece blank according to a manufacturing plan using a machine tool having a processing device, the method comprising:
a) at least partly transmitting the manufacturing plan using an order control device;
b) manufacturing at least one workpiece from the workpiece blank according to the manufacturing plan using the processing device;
c) determining a manufacturing progress of the processing device during the manufacturing of the at least one workpiece using the order control device; and
d) changing the manufacturing plan on the basis of the manufacturing progress during the manufacturing of the at least one workpiece using the order control device.

2. The computer-supported manufacturing method according to claim 1, wherein the machine tool is designed as a laser cutting machine.

3. The computer-supported manufacturing method according to claim 1, wherein the manufacturing plan is changed for unfinished workpieces.

4. The computer-supported manufacturing method according to claim 3, wherein the at least one workpiece is manufactured using the processing device according to a manufacturing sequence defined in the manufacturing plan, and wherein the order control device changes the manufacturing sequence of the unfinished workpieces of the manufacturing plan during the manufacturing of the at least one workpiece.

5. The computer-supported manufacturing method according to claim 1, wherein the order control device supplements the manufacturing plan by at least one further supplementary workpiece to be manufactured.

6. The computer-supported manufacturing method according to claim 5, further comprising:
e) identifying a manufactured defective and/or damaged workpiece,
wherein the at least one further supplementary workpiece to be manufactured corresponds to the manufactured defective and/or damaged workpiece.

7. The computer-supported manufacturing method according to claim 1, wherein the order control device removes the at least one workpiece to be manufactured from the manufacturing plan.

8. The computer-supported manufacturing method according to claim 1, wherein the order control device changes the arrangement of unfinished workpieces on the workpiece blank.

9. The computer-supported manufacturing method according to claim 1, wherein the manufacturing plan is divided into at least two manufacturing sections, and wherein the manufacturing sections are transmitted separately from one another from the order control device to the processing device.

10. The computer-supported manufacturing method according to claim 9, wherein each workpiece to be manufactured is manufactured in a separate manufacturing section.

11. The computer-supported manufacturing method according to claim 9, wherein the order control device transmits the manufacturing sections to the processing device on the basis of the manufacturing progress.

12. The computer-supported manufacturing method according to claim 11, wherein the order control device transmits a manufacturing section to the processing device when the previously transmitted manufacturing section has been processed by the processing device.

13. The computer-supported manufacturing method according to claim 1, wherein the processing device sends the manufacturing progress to the order control device during processing of the manufacturing plan.

14. The computer-supported manufacturing method according to claim 1, comprising a further processing device for manufacturing workpieces according to a further manufacturing plan, wherein the manufacturing plan of the processing device is changed depending on a change in the manufacturing plan of the further processing device.

15. A manufacturing system comprising at least one processing device and the order control device configured to execute the manufacturing method according to claim 1.

16. The method computer-supported manufacturing method according to claim 1, wherein the machine tool is a flat-bed machine tool.
